(19) United States
(12) Patent Application Publication
(10) Pub. No.: US 2010/0115426 A1
(43) Pub. Date: May 6, 2010

(54) AVATAR ENVIRONMENTS

(75) Inventors: Agnes Liu, Walnut, CA (US); Francisco Vinoly, Venice, CA (US); Brian Channell, Redondo Beach, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/265,513

(22) Filed: Nov. 5, 2008

(51) Int. Cl. G06F 3/048

(52) U.S. Cl. 715/757

(57) ABSTRACT

Embodiments are directed towards providing dynamic and interactive avatars of social networking members for use in visually displaying interactions and activities within a messaging context. A user interface is provided that enables relationships toy be displayed within a messaging context through automatic and/or dynamic grouping and/or re-arranging of avatars representing the member and a messaging user. Similar to, albeit it different from, an actual social event/party the dynamic displaying of members' avatars reflects how groups of people may interact. Thus, the disclosed embodiments provide a dynamic visual interface illustrating social congregation and interactions between members of a messaging social network.

### FIELD OF ART

The present invention relates generally to visual computer interfaces, and more particularly to a dynamic social community structured visual interface for managing a messaging environment.

### BACKGROUND

Tremendous changes have been occurring in the Internet that influence our everyday lives. For example, online social networking has become the new meeting grounds. They have been called the new power lunch tables and new golf courses for business life in the U.S. Moreover, many people are using such online social networks to reconnect themselves to their friends, their neighborhood, their community, and the world. The development of such online social networks touch countless aspects of our everyday lives, providing instant access to people of similar mindsets, and enabling us to form partnerships with more people in more ways than ever before.

Online social networking may be accomplished using a variety of messaging applications, including, but not limited to email, Instant Messaging (IM), Short Message Service (SMS), Chat, or the like. While there may be a large variety of messaging applications from which a user may choose, often they employ traditional user interface mechanisms. Such traditional user interfaces may include, for example, a listing of contacts from which the user may select one or more contacts with which to communicate. The communications may then include entering text messages with the one or more selected contacts. Such traditional user interfaces may come across to some users as ‘medieval,’ or overly simplistic, providing little or no dynamic aspects to their social networking activities. For still other users, such interfaces may be overly complex, requiring multiple menu selections, and/or even searches to select contacts, and/or initiate a communication with the selected contacts. As a result many users, while ‘struggling through’ with such user interfaces may prefer more user-friendly interfaces.

Thus, as social networking transforms our lives, many businesses continue to struggle to keep up, and provide value to the user in such a structure. Without the ability to extend value to a user's online experience, user loyalty to a business may quickly diminish. Thus, many businesses are searching for new ways to provide users with improved, more user-friendly interfaces that may improve social networking and communications in general. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device, according to one embodiment of the invention;

FIG. 3 shows one embodiment of a network device, according to one embodiment of the invention;

FIGS. 4-11 show various embodiments of screen shots of messaging client user interfaces, illustrating possible displays of avatars; and

FIG. 12 illustrates a logical flow diagram generally showing one embodiment of a process for determining display aspects of avatars in an interactive avatar messaging environment.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “social network” and “social community” refer to a concept that an individual's personal network of friends, family colleagues, coworkers, and the subsequent connections within those networks, can be utilized to find more relevant connections for a variety of activities, including, but not limited to dating, job networking, service referrals, content sharing, like-minded individuals, activity partners, or the like.

An online social network typically comprises a person's set of direct and/or indirect personal relationships, including real and virtual privileges and permissions that users may associate with these people. Direct personal relationships usually include relationships with people the user can communicated with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships typically include relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship.

The term “vitality” as used herein refers to online and/or offline activities of a member of a social network. Thus, vitality information is directed towards information associated these aspects of a social community, through various communications between members, and their activities, and/or states of various members, or the like. Vitality information may include, but is not limited to a location of a member, weather information where the member is located, an event, information from the member's calendar or even a friend's calendar, information from the member's task list, past behavior of the member of the social network, a mood of the member, or the like. Vitality information however, is not limited to these examples, and other information that may describe the lively, open, or animated aspects of a social network's members may also be employed. Thus, in one embodiment, vitality information might be available through a member's activities on a network, such as blog publications, publishing of photographs, or the like. A lifestream may be one mechanism useable to provide at least some vitality information to another user.

As used herein lifestreaming refers to a mechanism for crawling an online record of a user's daily activities by aggregating their online content from such as blog posts, vlog posts, online photo sites, and/or any of a variety of other specified social network sites for use in sharing with other users. Users may provide their usernames for different sites. A lifestreaming aggregator then crawls the identified sites and aggregates or collects updates for the user to then share with others.

The following briefly describes embodiments of the invention in order to provide a basic understanding of some aspects of the invention. This brief description is not intended as an extensive overview or to otherwise narrow the scope of the invention. Its purpose is merely to present some concepts in a simplified form.

Briefly stated, embodiments of the invention are directed towards providing dynamic and interactive avatars of social networking members for use in visually displaying interactions and activities within a messaging context. Relationships between the members' of the social network and a current user may be illustrated through automatic and/or dynamic grouping and/or re-arranging of avatars representing the member and the current user. For example, members' avatars may be automatically visually grouped and/or re-arranged based on how a user classifies the relationships, based on a geophysical proximity to other members and/or the user, whether a user is communicating with the other member(s), and/or based on interests. Moreover, whether a member is offline, in communication with one or more other members and/or the user, and/or has not communicated with the user for some time period may automatically impact where the member's avatar is illustrated with respect to other avatars, as well as how the avatar is displayed. Similar to, albeit it different from, an actual social event/party the dynamic displaying of members' avatars seeks to reflect how groups of people may interact. Thus, unlike merely displaying an avatar as an ordered listing of names or aliases, with associated avatars, and/or online/offline status, the disclosed embodiments are directed towards providing a dynamic visual interface illustrating social congregation and interactions between members of a social network.

The messaging context may employ any of a variety of messaging protocols, including but not limited to text messaging protocols, audio protocols, graphical messaging protocols, and/or a combination of text, graphics, and/or audio messaging protocols.

### Illustrative Operating Environment

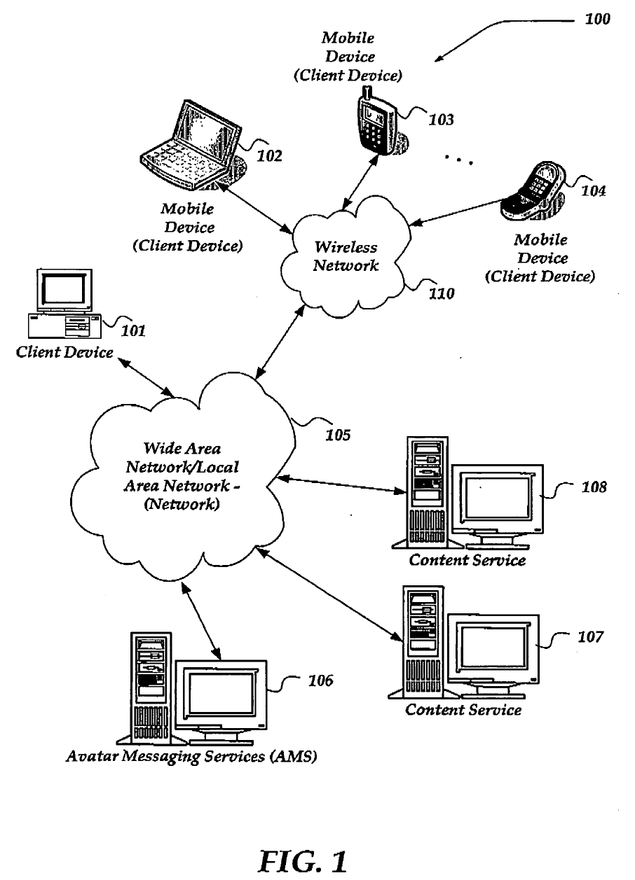

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, Avatar Messaging Services (AMS) 106, client devices 101-104, and content services 107-108.

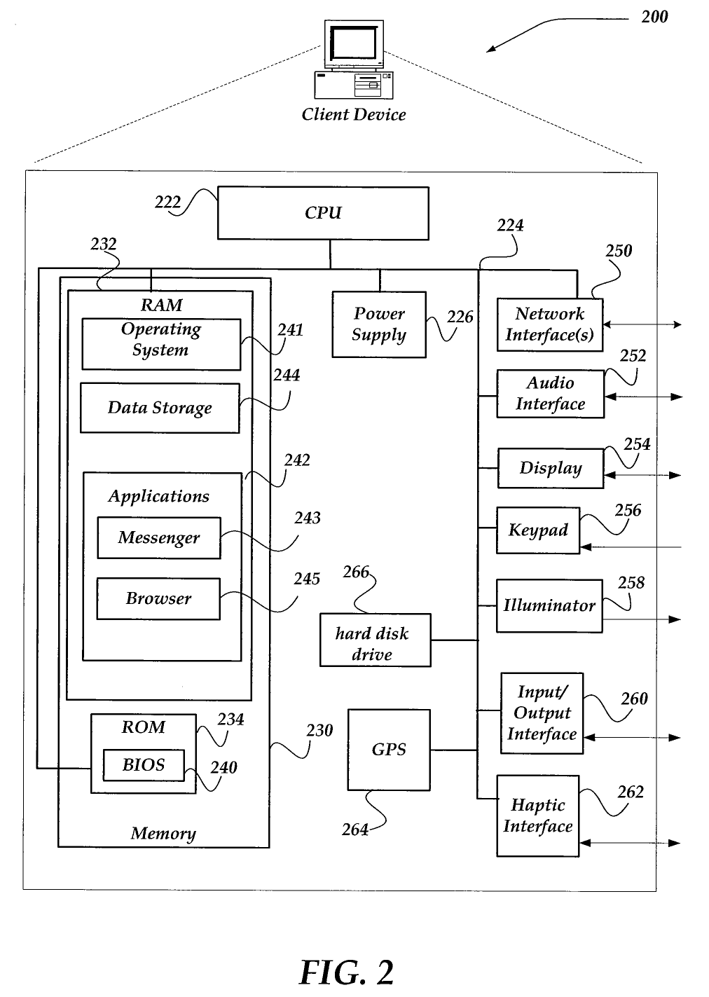

One embodiment of client devices 102-103 is described in more detail below in conjunction with FIG. 2. Generally, however, client devices 102-104 may include virtually any portable computing device capable of receiving and sending a message over a network, such as network 105, wireless network 110, or the like. Client devices 102-104 may also be described generally as client devices that are configured to be portable. Thus, client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information, including social networking information, performing search queries, or the like. Client device 101 may also include client applications such as those described above, as well as being configured to provide location information.

The set of such devices may include devices that typically connect using a wired or wireless communications medium such as personal computers, multiprocessor systems, microprocessor-based or programmable consumer electronics, network PCs, or the like. Moreover, at least some of client devices 102-104 may operate over wired and/or wireless network.

A web-enabled client device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Asynchronous JavaScript (AJAX), Standard Generalized Markup Language (SMGL), HyperText Markup Language (HTML), eXtensible Markup Language (XML), and the like, to display and send a message. In one embodiment, a user of the client device may employ the browser application to communicate with others over the network. However, another application may also be used to communicate with others over the network.

Client devices 101-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent to AMS 106, content services 107-108, or other computing devices.

Client devices 101-104 may further be configured to include a client application that enables the end-user to log into an end-user account that may be managed by another computing device, such as content services 107-108, AMS 106, or the like. Such end-user account, for example, may be configured to enable the end-user to receive emails, send/receive IM messages, SMS messages, access, and/or modify selected web pages, participate in a social networking activity, or the like. However, participation in various social networking activities, or the like, may also be performed without logging into the end-user account.

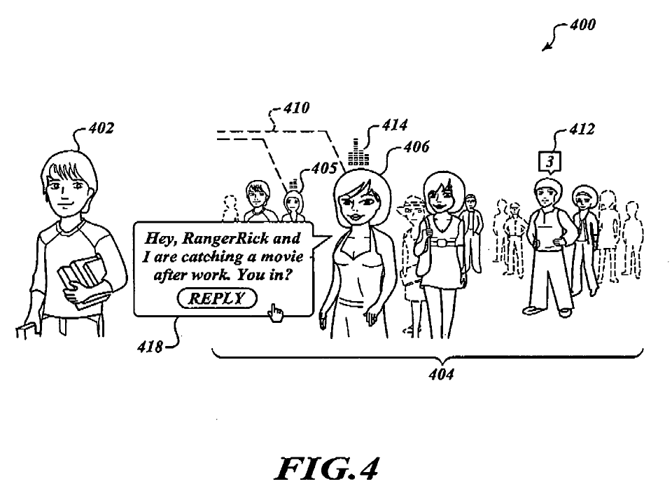

Client devices 101-104 may be configured to enable a user to view dynamic avatars during a social networking communications, using any of a variety of communication protocols, including, but not limited to IM, SMS, Multimedia Messaging Service (MMS), Chat, Voice Over IP (VOIP), or the like. In one embodiment, based on a characteristic of the client device, the dynamic avatars may be displayed in a human-like form, such as illustrated in FIGS. 4-11, which are described in more detail below. However, in another embodiment, the avatars may be displayed using various other mechanisms based on a capability of a client device. Thus, for example, for client devices with smaller screen sizes, slower network connections, or the like, the avatars might be displayed using such as stick figures, colored balls, lines, stars, or any of a variety of other less compute intensive forms. However, whether the avatar is a ‘fully structured’ figure, or a more simplistic structure, the avatars may still be configured to move locations, change colors, shapes, or the like, to dynamically reflect interactions between the members for which they represent. A user of a client device may employ such a dynamic avatar display to initiate and/or otherwise participate in communications with others, share moods, perform lifestreaming, or any of a variety of other forms of communications with others over a network. For example, in one embodiment, a user might employ such dynamic avatar messaging environment to provide an advertisement, an invitation, promotions, virtual gifts, or other information to others.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, AMS 106, content services 107-108, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

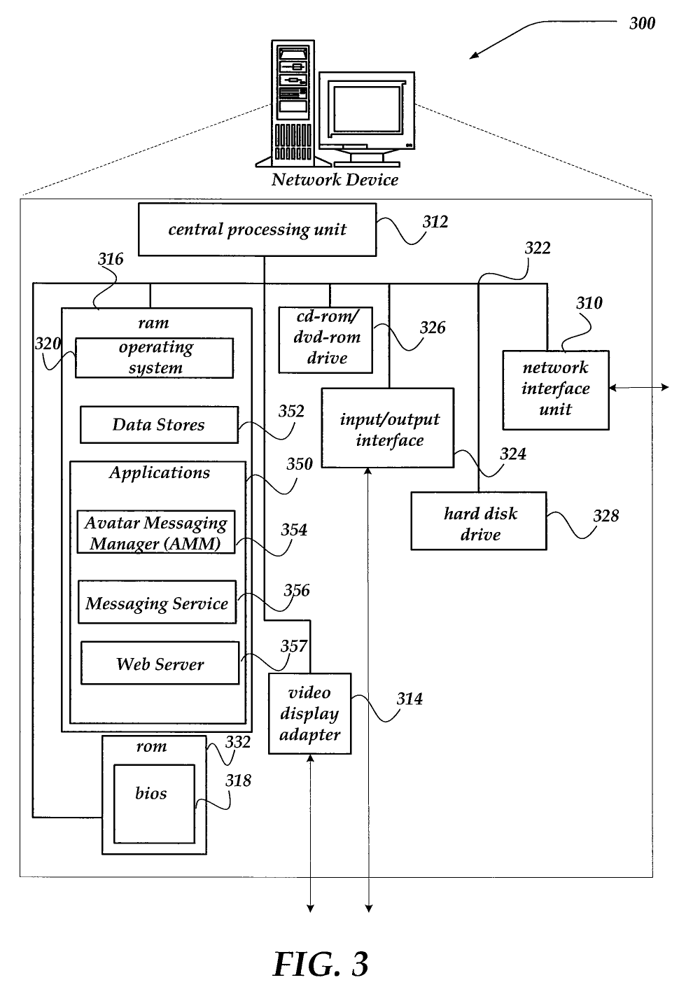

One embodiment of AMS 106 is described in more detail below in conjunction with FIG. 3. Briefly, however, AMS 106 may include any computing device capable of connecting to a network to manage an interactive avatar messaging service. AMS 106 may be configured to receive information about with whom a user may communicate. Such information might be obtained from a user's address book, buddy list, or any of a variety of other contact sources. AMS 106 might further obtain information about with whom members may be communicating with, and/or have communicated with, for use in generating a dynamic avatar display. Such avatar display may be configured to dynamically display such communications between members of a social network using a spatial relationship between avatars, a shading or coloring of avatars, connector links, conversation bubbles, or any of a variety of other mechanisms as described in more detail below.

AMS 106 may enable a user of a client device, such as client devices 101-104 to select an avatar representing another user, for which the user may want to communicate. Moreover, AMS 106 provides a dynamic display illustrating with whom other users may be communicating with, in addition to, and/or other than the current user. AMS 106 may enable communicates between members using any of a variety of messaging protocols, including but not limited to IM, SMS, MMS, VOIP, email, or the like.

Devices that may operate as AMS 106 include various network devices, including, but not limited to personal computers, desktop computers, multiprocessor systems, microprocessor-based or programmable consumer electronics, network PCs, servers, network appliances, and the like.

Although FIG. 1 illustrates AMS 106 as a single computing device, the invention is not so limited. For example, one or more functions of AMS 106 may be distributed across one or more distinct computing devices. For example, managing an avatar display may be performed by one computing device, while enabling messaging, managing user preferences, address books, or the like, may be performed by another computing device, without departing from the scope or spirit of the present invention.

Content services 107-108 represents any of a variety of network devices to provide content and/or services accessible by client devices 101-104. Such services include, but are not limited to merchant sites, educational sites, personal sites, music sites, video sites, and/or the like. In fact, content services 107-108 may provide virtually any content and/or service that a user of client devices 101-104 may want to access. In one embodiment, content services 107-108 may include personal blogs, vlogs (video logs), photo sites, or the like, for which a user may want to share with another user. In one embodiment, content services 107-108 may provide various websites that a user might include in a lifestream to another user. In still another embodiment, content services 107-108 may also include various content and/or services which might be useable within an advertising context, and/or other promotional contexts, including, but not limited to sponsored advertisements, sponsored promotions, or the like.

Devices that may operate as content servers 107-18 include personal computers desktop computers, multiprocessor systems, microprocessor-based or programmable consumer electronics, network PCs, servers, and the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, client device 200 may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including, but not limited to address books, buddy lists or other contact sources, aliases, avatars, user preferences, or the like. At least a portion of the information may also be stored on hard disk drive 266, or other storage medium (not shown) within client device 200.

Applications 242 may include computer executable instructions which, when executed by client device 200, transmit, receive, and/or otherwise process messages, audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In one embodiment, browser 245 may be configured to enable access to a dynamic avatar messaging service, such as provided through AMS 106 of FIG. 1. Thus, browser 245 might provide a dynamically changing display of avatars that may be useable to allow a user to interact and communicate with other users over a network. Browser 245 might employ any of a variety of dynamic protocols, scripts, applets, or the like to enable such communications. In another embodiment, browser 245 might enable a user to access, and/or download a program, script, or the like, that enables such dynamic avatar interactions. Thus, the invention is not limited to any single programming language, scripting mechanisms, or the like. In any event, in one embodiment, browser 245 may be arranged to communicate with messenger 243 to enable messaging to be integrated with the avatar displays.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, VOIP, and/or the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols, including, but not limited to various push and/or pull mechanisms for client device 200. As described above, messenger 243 may integrate with browser 245 to enable an integrated avatar messaging display.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, AMS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer-readable storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

As shown, data stores 352 may include a database, text, spreadsheet, folder, file, or the like, that may be configured to maintain and store user data, including but not limited to user preferences, avatars, contact source data, information about online activities of users, status of communications between users, lifestreaming information, vitality information, and/or other display information useable for managing a avatar messaging environment, or the like. In one embodiment, at least some of data store 352 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Web server 357, messaging server 356, and Avatar Messaging Manager (AMM) 354 may also be included as application programs within applications 350.

Web server 357 represent any of a variety of services that are configured to provide content, including messages, over a network to another computing device. Thus, web server 357 includes for example, a web server, a File Transfer Protocol (FTP) server, a database server, a content server, or the like. Web server 357 may provide the content including messages over the network using any of a variety of formats, including, but not limited to WAP, HDML, WML, SMGL, HTML, XML, cHTML, xHTML, dHTML, JavaScript, AJAX, or the like. Thus, in one embodiment, web server 357 may be configured to enable search queries, provide search results, and to enable a display of a list of other users for use in initiating a chat session, and/or other form of communications.

Messaging server 356 may include virtually any computing component or components configured and arranged to forward messages from message user agents, and/or other message servers, or to deliver messages to a local message store, such as data store 354, or the like. Thus, messaging server 356 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. Messaging server 356 may also be managed by one or more components of messaging server 356. Thus, messaging server 356 may also be configured to manage SMS messages, IM, MMS, IRC, RSS feeds, mIRC, or any of a variety of other message types. In one embodiment, messaging server 356 may enable users to initiate and/or otherwise conduct chat sessions, VOIP sessions, or the like, and/or perform any of a variety of interactive communications with others, using for example, a dynamic avatar messaging interface. Thus, in one embodiment, messaging server 356 may be configured to interact with web server 357, and/or any of a variety of other components useable to enable such communications.

AMM 354 may be configured to interact with web server 357, messaging server 356, and/or other components not shown, including components that may reside on a client device, or other network device, for enabling a dynamic avatar messaging environment. AMM 354 might, in one embodiment, provide components for download to a client device, for use in displaying and/or otherwise interacting with a visual interactive display of messaging avatars. In another embodiment, AMM 354 may manage display elements that may be provided to web server 357 for use in displaying messaging avatars.

AMM 354 may obtain information about users of the avatar messaging environment through a variety of sources, including, but not limited to monitoring communications of the users, obtaining information from address books, buddy lists, or any other contact source information. AMM 354 may also provide a user preference interface configured to enable a user to select and/or modify an avatar useable to represent the user to others. In one embodiment, the avatar the user selects may be displayed to the user as well. The user may provide a variety of other user preferences, including, but not limited to types of mechanisms to be used for displaying various actions, such as when users are communicating, or the like. The user may also provide AMM 354 various information, such as sources where a user's lifestreams might be found, blogs, vlogs, or the like, might be located. However, in another embodiment, AMM 354 might discern such information based on monitoring of the user's actions over the network. In one embodiment, AMM 354 might also determine relationships between users based on content of a user's address book, and/or other users' address books and/or other contact sources, or the like. For example, AMM 354 might determine first degree of separation relationships, second degree of separation relationships, and so forth, based, at least in part on monitored actions, and/or content of a user's address book, and other user's address books, or the like.

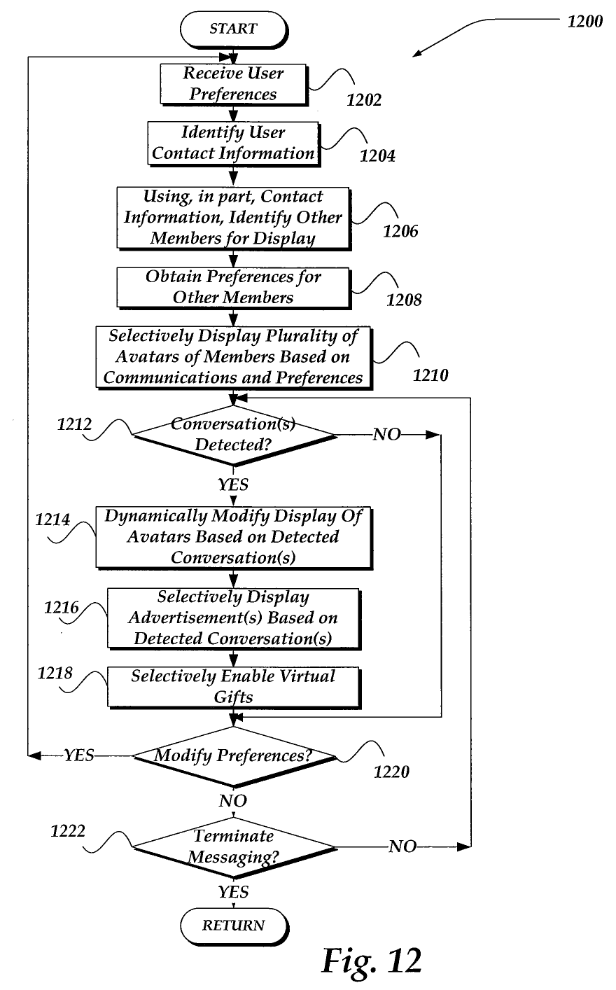

AMM 354 may provide and manage such visual interactive avatar displays as described in more detail below. Moreover, in one embodiment, AMM 354 might employ a process such as described in more detail below in conjunction with FIG. 12 to perform at least some of its actions.

### Non-Limiting Illustrative Screen Display

User interfaces and operations of certain aspects of embodiments of the present invention will now be described with respect to FIGS. 4-11. Such dynamic interfaces may include more or less components than illustrated. The components shown, however, are sufficient to disclose an illustrative embodiment for practicing the invention. As noted above, in one embodiment, AMM 354 of FIG. 3 may be employed, alone, or in conjunction with one or more other components, to provide such dynamic avatar messaging environment.

FIG. 4 shows one embodiment of a screen shot of a messaging client user interface, illustrating one non-limiting, non-exhaustive display of avatars in a display area. As shown, display 400 includes avatar 402 representing a current user that is viewing display 400, and a plurality of avatars 404 representing members with which the current user may communicate. It is noted that each of the plurality of avatars 404 as well as the current user's avatar 402 may be configured to appear based on a user's preferences. Thus, for example, a user of the avatar messaging environment might be provided with a set of possible avatars from which to choice one to represent themselves. In another embodiment, the user might provide an avatar to be used to represent themselves. Moreover, in various embodiments, the user might be allowed to vary the coloring, size, shape, clothing, or virtually any of a variety of other features of their avatar. In one embodiment, the current user may further be able to override display preferences of other members, at least for the current user's own display 400, and modify how other members' avatars appear. Thus, for example, the current user might be able to vary a coloring, shape, size, clothing, or the like, of other members' avatars.

In one embodiment, the user might also be enabled to select various backgrounds for placement of the avatars, including, but not limited to providing photographs, and/or selecting from a set of possible background scenes. In one embodiment, the background may be automatically selected for each user based on a location of the current user, location of a person with whom they may be communicating, based on the weather where the current user is located, or any other variety of other selection criteria. As used herein, the term “automatically,” refers to actions taken independent of additional input from a user.

As shown in the figure, plurality of avatars 404 may represent contacts within the user's address book and/or other contact sources. Thus, the number of avatars shown might represent the number of contacts with which the current user might be able to communicate. However, in another embodiment, the number of avatars illustrated might be constrained based on a client device limitation, a network connection constraint, or the like.

A user viewing display 400 may click on or within a defined proximity of any avatar within plurality of avatars 404 to begin and/or respond to a request for a conversation. In one embodiment, a comment window, such as conversation bubble 418 may be displayed to enable the user and the selected avatar (as represented by avatar 406) to communicate. As shown, if other members are communicating with each other, a link 410 might be illustrated. Moreover, in one embodiment, a communication indicator 414 might be displayed above, or near, the communicating members' avatars. Thus, as shown in FIG. 4, members represented by avatars 405 and 406 may be communicating with each other, with communication indicators 414 illustrated above the respective avatars. Although communication indicators 414 are illustrated as histogram bars, the invention is not so limited. Thus, for example, communication indicators 414 may also be illustrated as pies, lights, stars, or virtually any other symbol, text, graphic, or the like. In one embodiment, communication indicators 414 might not be shown. Moreover, in one embodiment, communication indicators 414 might, indicate a topic with which the members are communicating. Thus, a graphic representing food, sports, news, music, shopping, or the like, might be employed instead. Such use of topic graphics, however, might be restricted based, in part, on whether the conversation between the other members is restricted. Where the avatars, such as avatars 405-406, are in communication with the current user (as represented by avatar 402), the topic graphics might be displayable.

If the current user selects to communicate with a member for which that member's avatar is currently displayed further back from others (for example, as shown by avatar 412 being ‘behind’ avatar 414), the selected avatar may automatically move forward in animation to be brought up to the front. In one embodiment, the avatar may be illustrated as walking, running, gliding, or performing some other action as it moves forward. In one embodiment, where the avatar joins a current conversation, the avatar might move forward to be about a same position forward in display 400 as other avatars participating in the conversation.

As further displayed, avatar 412 might represent a member that may have messages to be communicated to the current user. Thus, in one embodiment, avatar 412 might include a communication indicator that includes a number of un-read messages (as shown here, three), for the current user.

A current user may also be provided with a capability of modifying a perspective of display 400. Thus, in one embodiment, the current user might be allowed to zoom in on one or more aspects of display 400, including, for example, zooming in on various avatars, the background, or the like. Moreover, the current user might change perspective to such as an over head view, side view, back view, or the like.

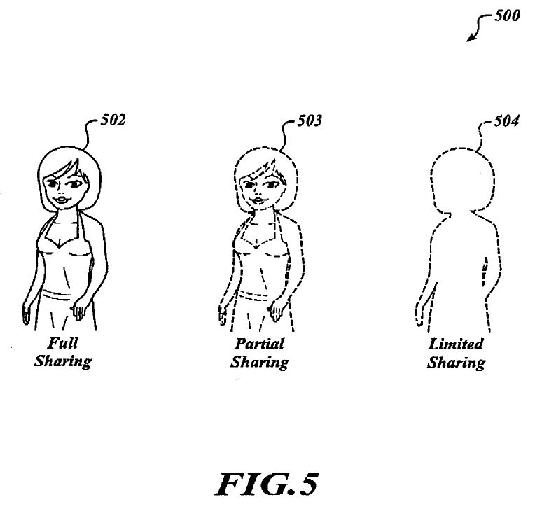

FIG. 5 shows one embodiment of a screen shot of a messaging client user interface, illustrating one non-limiting, non-exhaustive display 500 of avatars representing various levels of sharing. As shown in display 500 avatars 502-504 represent embodiments useable for illustrating possible user privacy preferences. It is noted that other mechanisms may be used to illustrate such preferences. Therefore, the invention is not limited to a single mechanism. However, as shown, avatar 502 represents a full sharing member, which may include message sharing, contact information, and/or history of various activities in which the member may participate. As shown, avatar 502 is a fully displayed figure.

Avatar 503 represents one embodiment of a member where the member has selected partial sharing, in that at least some information about the member is made unavailable to other members. For example, in a partial sharing, the member might select to make unavailable to other members access to their history of online activities. However, other information, such as messages might be made available to other members. Thus, for example, a member that selects partial sharing might restrict others from knowing about that member's online browsing activities, their online purchases, and/or online postings, or the like. As shown, such partial sharing might be represented by avatar 503 where the avatar might be dimmed out, or faded, or more translucent than the display of a full sharing avatar, such as avatar 502.

Avatar 504 might be used to represent members that have selected limited sharing. For example, the member might select to enable messages to be shared, but not contact information or online activities. Thus, in one embodiment, a member selecting limited sharing might have their avatar displayed to others using a fully faded or darkened display as shown in FIG. 5. As noted, other mechanisms may also be used to illustrate a user's sharing preference, including, but not limited to a coloring, shading, a symbol associated with the avatar, or the like. Moreover, privacy preferences might include more or less than the examples described above. Thus, for example, a user's name, location, or other type of information might also be selectively shared based on a user's preference settings.

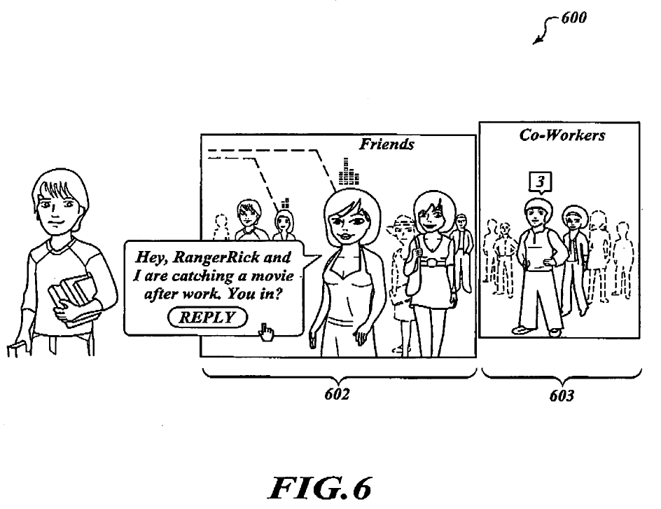

FIG. 6 shows one embodiment of a screen shot of a messaging client user interface, illustrating one non-limiting, non-exhaustive display of avatar groupings. Avatars may be grouped into visual clusters within a display based on a variety of criteria. Groupings may be based on relationships that the current user has identified. Such identification might be based on tags, or other labels, the current user has provided in their contact information. Thus, for example, as illustrated in FIG. 6, avatars may be grouped in a friends group 602, or a co-worker group 603. However, other groupings may also be employed, including, but not limited to family, church members, poker buddies, or the like. Virtually any named group may be used to organize avatars.

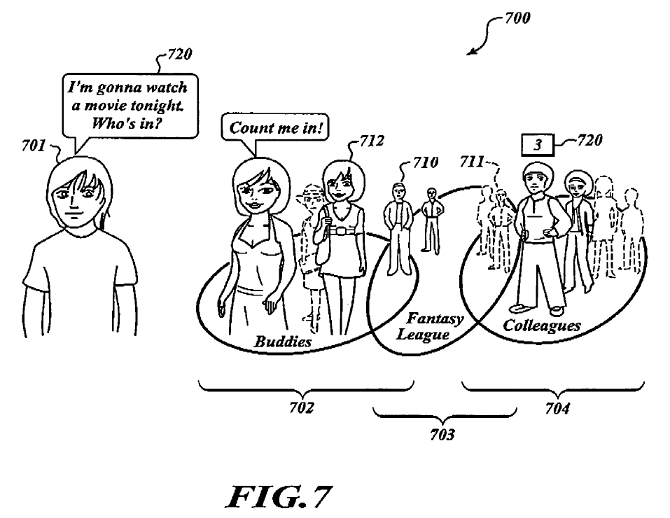

However, groupings may also be based on criteria, including, for example, location. For example, a member's geophysical location might be obtained from their client device, IP address, user specified input, or the like. Using such location information, avatars may then be grouped based on geographic proximity. In still another embodiment, groupings may be based on common interests, membership to an organization, or the like. Thus, as illustrated in FIG. 7, avatars are shown being grouped based on a buddy relationship (group 702), a fantasy league membership (group 703), or where classified as colleagues (group 704). Other groupings are also possible, and thus, these examples are not to be construed as limiting. Moreover, as shown in FIG. 7, members may be included a more than one group. Thus, as shown in FIG. 7, avatar 710 (the member represented by avatar 710), for example, is shown to be a member of groups 702 and 703, while avatar 711 (that is, the member represented by avatar 711) is shown as a member of groups 703 and 704.

Moreover, the current user may be enabled to modify groupings of avatars based on any of a variety of criteria. Thus, in one embodiment, the current user may select a first grouping for some members, while a second grouping scheme for other members. Still, in another embodiment, the current user might modify a user preference, and/or other display parameter to dynamically change how members' avatars are grouped.

Referring to FIG. 7, a member's online status may also be displayed using avatars. For example, as shown, avatar 711 is shown grayed out or gray silhouetted, to indicate, in one embodiment, that the member is offline, and unavailable for participation presently in a conversation. A member's online status may also be illustrated using any of a variety of other mechanisms. Thus, for example, the member's avatar might be transparent or opaque to indicate that the member is offline; the avatar might be grayed out, not colored, or displaying other forms of fidelity to indicate the online status; the avatar might be sized smaller than surrounding avatars; or a position of the avatar with respect to other avatars might be modified. For example, the avatar might be moved away from the current user's avatar 701 such as moved to the right in display 700 of FIG. 7. A distance away from current user's avatar 701 in display 700 may also be used to indicate a duration between a last conversation with the current user. Thus, similar to a timeline, avatars placed closer in proximity to current user's avatar 701 may indicate a more recent interaction with the current user that avatars placed further away in proximity to the current user's avatar 701. For example, avatar 712 might represent a more recent communication having occurred with the current user, than a communication between the member represented by avatar 711, or even avatar 710 and the current user. In one embodiment, such positioning of avatars may be dynamically revised, automatically for a current user's display.

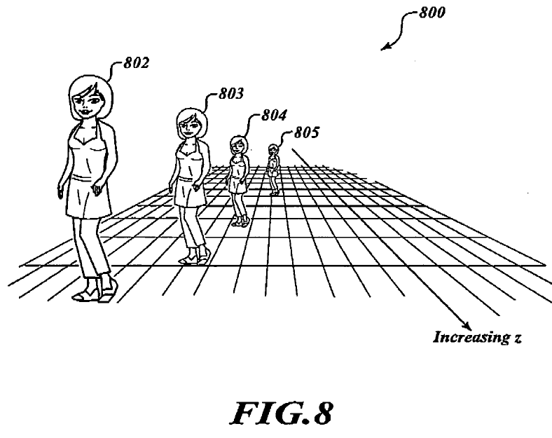

Referring briefly to FIG. 8, several avatars, 802-805 are displayed to show one embodiment of illustrating interactions with the current user. Thus, as shown, members having a higher level of interaction with the current user may have their avatar displayed closer with respect to a z-axis of display 800, than other avatars. As shown, avatar 802 represents a member having a higher level of interaction with the current user than members represented by avatars 802-805. Similarly, avatar 805 might represent a member having a lesser amount of relative interaction with the current user as compared to members represented by avatars 802-804.

Moreover, in one embodiment, an avatar that is placed in a back of a group might indicate that the member is offline. However, in one embodiment, if the member has left an offline message, the position of the avatar might be modified. For example, if the member left an offline message, the member's avatar may display an icon, such as icon 720 of FIG. 7, indicating a message is available for the current user. Moreover, in one embodiment, the associated avatar might be automatically repositioned to a front of other avatars with a group, across groups, or the like.

As an aside, display 700 of FIG. 7 provides another embodiment of displaying messages, as shown by conversation bubble 720. However, the invention is not limited to such message display mechanisms, and others may also be used. Thus, graphics may be used, rolling text windows might be employed, or the like, without departing from the scope of the invention.

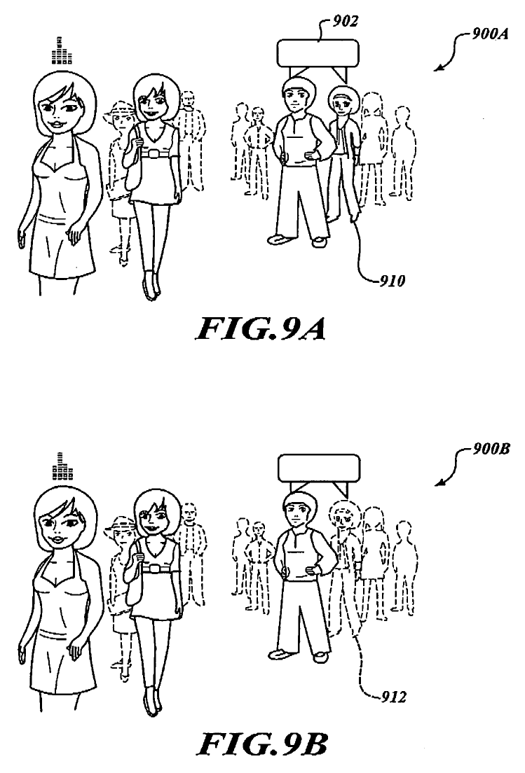

FIGS. 9A-9B shows one embodiment of screen shots of a messaging client user interface, illustrating non-limiting, non-exhaustive displays of interactions between members as represented by their respective avatars. As shown in displays 900A/B of FIG. 9A-9B, if members are conversing with each other, the avatars might be automatically relocated to within a close proximity to each other. Moreover, various other mechanisms might be employed to indicate that they are communicating. For example, as shown in FIG. 9A, if the two members that are conversing are in a contact list of the current user, and are not in a conversation with the current user, then a conversation bubble 902 might appear. As shown, because the conversation does not include the current user, conversation bubble 902 might be configured such that the current user is unable to read the communications between the other members. If the two members select to share the communications with the current member, then the communication within communications bubble 902 would be displayed to the current user. Moreover, the avatars of the communicating members would, in one embodiment, automatically moved forward in display 900A. In one embodiment, a visual icon might be available to the current user indicating a name of the other members that are having a conversation.

As shown in FIG. 9B, however, if a member that is in the current user's contact list is conversing with a member that is not in the current user's contact list, then the avatar of the user not in the current user's contact list might be displayed in transparent form to indicate that the other member is not in the user's contact list. In FIG. 9A, avatar 910 represents another member that is in the current user's contact list, while avatar 912 of FIG. 9B represents another member that is not in the current user's contact list. Avatar 912 therefore may represent one embodiment of a second degree of separation relationship to the current user. However, the avatar messaging environment is not constrained to merely illustrating first and/or second degree of separation relationships, and higher degrees may also be illustrated. Such information may be determined using a variety of mechanisms. For example, in one embodiment, an examination of members' contact sources might be used to develop a relationship diagram, or the like, useable to indicate degree of separation between members.

As stated elsewhere, avatars may be located in close proximity to each other, along with displaying a conversation bubble to indicate that the respective members are holding a conversation. As before, for privacy reasons, the conversation bubble might be configured such that the current user is unable to read the transpiring communications between the other members. If the two members select to share the conversation, the conversation bubble may automatically reveal the conversation to the current user.

If a member is online, the member's avatar may be grouped based on a variety of criteria, including those described above. Moreover, as noted, when a member is online, the member's avatar may be displayed in full fidelity, including, for example, in one embodiment, full color, fully opaque, unless the member elects to make their avatar invisible to the current user. The member's avatar may also use various sizes to indicate a number of interactions with the current user. In one embodiment, the more the current user interacts with a member, the larger and/or more forward in the display the avatar may become. Similarly, the fewer interactions, the further back, more transparent, and/or smaller, the member's avatar may become. Moreover, as noted elsewhere, in one embodiment, a position of an avatar relative to the avatar of the current user may reflect a number of interactions with the current user, where the more active, the more positioned to the left of the display (or closer to the current user's avatar), the fewer the interactions, the further positioned away from the current user's avatar. Similarly, if a member sends a message to the current user, the member's avatar may move forward in front of other avatars. It should be noted, that while left or right with respect to the display of the current user's avatar may readily be modified based on a user preference. Thus, for example, while the current user's avatar might be displayed in a left most position of a display, in another embodiment, the user might relocate their avatar to be in a center, a rightmost position, or virtually any other location. Thus, the invention is not limited to a particular location of the current user's avatar, and others may be selected, without departing from the scope of the invention.

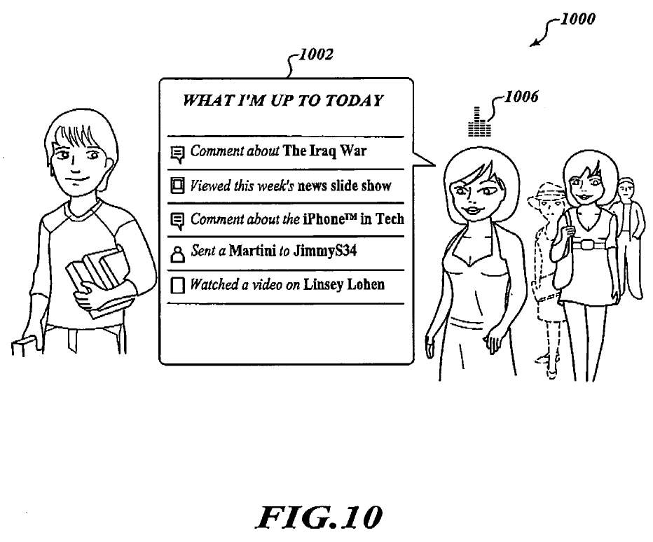

FIG. 10 shows one embodiment of a screen shot of a messaging client user interface, illustrating a non-limiting, non-exhaustive display of interactions between a member and the current user as represented by their respective avatars. As shown in display 1000 of FIG. 10, a member, as represented by their avatar (1006) might select to send a lifestream of status information to the current user. Such lifestreams, as shown in conversation bubble 1002 might include status of the member's online life activities. Such lifestream activities, may include, but are not limited to providing feeds associated with videos, blog comments, news articles of interest, or the like. In one embodiment, the member might select to provide to the current user (or vice versa), a virtual gift similar to an offline message as a token. Thus, for example, as shown in conversation bubble 1002, the member might select to send a virtual martini drink, fortune cookie, or the like, to another member, such as the current user. In one embodiment, providing of a virtual gift or other lifestream status may result in the member's avatar being brought forward in relation to other avatars in display 1000.

Moreover, the current user might point a screen display cursor, or other computer pointing icon, symbol, or the like, over an avatar. The result of such movement, in one embodiment, might enable a display of the member's lifestream information, and/or other information about the member, including, but not limited, for example, to the member's name or alias, how long the member has been online/offline, or the like; contact information such as a phone number, email address, or other contact information; lifestream information such as activities the member may be involved with, communications the member is in, or has recently conducted, and/or any of a variety of other vitality information that the member may have indicated is sharable with the current user.

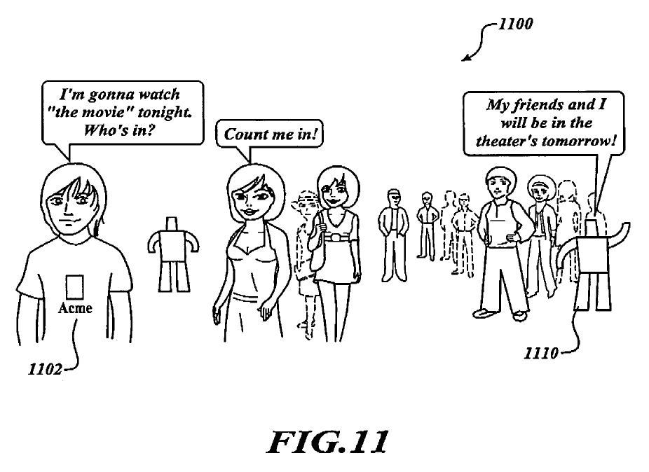

FIG. 11 shows one embodiment of a screen shot of a messaging client user interface, illustrating a non-limiting, non-exhaustive display of interactions between a member and the current user usable for providing sponsored advertisements. Thus, as shown in display 1100 of FIG. 11, a user may select to provide members sponsored advertisements, promotions, or the like. In one embodiment, a user can add sponsored characters as friends to their display, such as sponsored character 1110, for example. In one embodiment, the member, current user, or the like, might include various clothing that may include sponsored advertisements, promotions, or the like, such as, for example, shirt 1102 shown in FIG. 11. Other sponsored icons, symbols, or the like, might also be employed. For example, in one embodiment, the current user might modify a background that may include sponsored material, add various artifacts around the ‘room’ such as pictures, vehicles, books, music videos, or the like, without departing from the scope of the invention.

It is noted, however, that the sponsored advertisements, showings of brand names, or the like, may be provided as static information and/or dynamic information. Thus, for example, in one embodiment, shirt 1102 might include dynamic data that varies over time. Such dynamic data might include, but is not limited to sports' scores, sport team updates, stock quotes, news headlines, music headlines, gossip information, or the like. For example, in one embodiment, the dynamic data might include a display of a latest team score, virtually in real-time. In another embodiment, the dynamic data might include symbols, icons, graphics, or the like, that is animated. For example, the dynamic data might include a video, animated graphic, or the like. In still another embodiment, the displayed advertisement or other sponsorship might be selectively dynamic. For instance, mousing over the displayed advertisement, sponsorship, or the like, might activate the animation, play a video, play an audio clip, or the like. As noted above, while shirt 1102 might include such static and/or dynamic information, the invention is not so limited. Such dynamic data may appear virtually anywhere within the display, including, but not limited to on a coffee cup, a wall, as a separate display, on a book cover, or any of a variety of other locations, without departing from the scope of the invention.

Thus, as described above, a user may employ at least some of the various displays to enable an interactive dynamic and visually oriented messaging environment. Such avatar messaging environment may dynamically change to reflect communications between various members to provide a more user friendly, intuitive interface over more traditional displays that might merely include listings of names, aliases, and/or avatars.

It should be clear however, that other avatar shapes, characters, coloring, and/or patterning, grouping, or the like, may also be used, without departing from the scope of the invention. For example, where a user's client device might be restricted to black/white screens, smaller screen size, slower network connections, or the like, other mechanisms may also be used. For example, in one embodiment, colored bubbles might be used to represent members, different sized symbols might be used, or the like. Thus, the invention is not limited to a particular icon, or symbol implementation, and others may also be employed, without departing from the scope of the invention.

### Generalized Operation

The operation of certain aspects of the invention will now be described with respect to FIG. 12. FIG. 12 illustrates a logical flow diagram generally showing one embodiment of an overview of a process for managing display aspects of avatars in an interactive avatar messaging environment. Process 1200 of FIG. 12 may be implemented within AMS 106 of FIG. 1, in one embodiment.

Process 1200 begins, after a start block, where user's preferences may be received for use in managing avatar messaging. In one embodiment, the user might have registered for use of the interactive avatar messaging environment. In one embodiment, components might be downloaded onto the user's client device to enable the user to use the avatar messaging environment. In another embodiment, the user might access one or more interfaces configured to enable the user to select various user preferences, including but not limited to providing their name, alias, contact information, privacy preferences, selecting their avatar, selecting display configurations such as a background, promotional information, and/or the like. Clearly, the user may be enabled to select a variety of different user preferences. In one embodiment, at least some of the user preferences may be set to default values, to provide convenience to the user. Thus, for example, a positioning of the current user's avatar within a display might be set to default to a forward and leftmost position on the display. However, in another embodiment, the user may modify such settings. The user may also provide various tracking preferences for the user's online activities, provide their client device capabilities, provide location information, or the like.

Processing then may flow to block 1204, where the user may provide information about their contacts, including, but not limited to address books, buddy list, or the like. In one embodiment, such information may be searched for automatically, based on a user's name, alias, account number, or the like. In one embodiment, the user may specify how to group the avatars within a display, as described above. In another embodiment, such groupings may be automatically performed for the user, based on information obtained from the user's contact lists, the user's online activities, and/or the like. In one embodiment, the groupings may also be based on information obtained from the members identified for potential displaying of their avatars.

Processing then flows to block 1206, where a determination is performed to select the member's for which their avatars are to be displayed. In one embodiment, a subset of possible members may be selected. Such selection may be based on, for example, the user's client device's capabilities, network connections, or the like. In another embodiment, information from contact lists of other members, may also be used to identify second degree of separation, and/or greater, members for display.

Continuing to block 1208, preferences of the selected members may be obtained, including information about their privacy preferences, their avatars, and other user preferences. Flowing next to block 1210, based on the user preferences, the members' preferences, client device capabilities, and/or history of communications between members and the current user, history of member and/or the current user's online activities, a display of avatars is generated and provided for display at the current user's client device.

Process 1200 then flows to decision block 1212 where one or more conversations between members may be detected, a request for a conversation may be detected, and/or one or more conversations between the user and another member is detected. In one embodiment, detection of a request by the user to communicate with another member may also be detected. Thus, at decision block 1212, virtually any communication between members, members and the current user, or the like, may trigger a detection of a request for a conversation and/or a conversation. If a conversation is detected at decision block 1212, then processing flows to block 1214; otherwise, processing branches to decision block 1220.

At block 1214, the displayed avatars are dynamically modified to reflect the detected conversation. As noted above, because the display is directed towards reflecting social interactions of members, multiple conversations may be displayed. For example, to members may be communicating with each other, but not with the current user, while the current user is communicating with a third member. Thus, the display may dynamically reflect such interactions using a variety of mechanisms, including, but not limited to those above. For example, histogram bars, links, communication bubbles, or the like, may appear. Moreover, avatars may dynamically move in relationship to other avatars to further indicate with who a member and/or the current user may be in communication. In one embodiment, as avatars move, request to participate in a conversation, or the like, they may become animated, including moving their feet, waving hands, jumping, or any of a variety of other actions. In one embodiment, as members communicate, the avatars might be configured to reflect the member's mood, such as showing a saddened face, smiling face, laughing, or the like. Such mood information might be provided by the member associated with the avatar using any of a variety of mechanisms, including, but not limited to selecting a mood during the conversation. However, in another embodiment, the avatar messaging environment may monitor for keywords, symbols, or the like within a conversation, and employ the keywords, symbols, or the like, to display a mood. For example, in one embodiment, where the member types “LOL” for “laughing out loud,” the member's avatar may be modified to show laughing.

Moreover, it is noted that any time when a member selects to go offline or comes online, their avatar may disappear from the display, appear on the display, or otherwise be modified to reflect the member's online status.

Processing continues to block 1216, where if it is detected that a member selected to communicate sponsored information, promotions, or the like, such information may also be used to modify a display. Thus, for example, a member's avatar might be seen with a different shirt, hat, or other artifact reflecting the sponsored information. In one embodiment, the member might provide for display at the current user's client device a character, or the like, useable for further communication with the current user, such as described in more detail above.

Continuing to block 1218, during various communications, a member, and/or the current user, may send virtual gifts to each other. When such virtual gifts are sent, in one embodiment, the virtual gift may be selectively displayed. That is, the current user may select not to have such virtual gifts displayed, and instead merely received a message indicating that the virtual gift has been sent/received.

Process 1200 then flows to decision block 1220, where a determination is made whether the current user has selected to modify one or more of their preferences. Such determination may be made when the current user selects a menu, icon, enters a defined set of keystrokes, or the like. If such request is received, processing loops back to block 1202; otherwise, processing continues to decision block 1222. At decision block 1222, a determination is made whether the current user has selected to terminate the dynamic avatar messaging environment. If so, processing returns to a calling process to perform other actions. Otherwise, processing loops back to decision block 1212.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A network device, comprising:
a transceiver to send and receive data over a network; and
a processor that is operative to perform actions, comprising:
receiving contact information for a user, wherein the contact information includes information about a plurality of social networking members;
selectively displaying a plurality of avatars, each avatar representing one of the plurality of social network members, wherein the avatars are displayed relative to another avatar within a client device display screen based in part on a frequency of interaction with the user;
receiving a request for a communication between the user and a member represented by one of the displayed avatars; and
in response to the request automatically modifying a visual relationship between the avatar associated with the member participating in the communication with the user and at least one other displayed avatar.

2. The network device of claim 1, wherein modifying a visual relationship further comprises moving the avatar associated with the member participating in the communication further forward with respect to a z-axis, such that the avatar appears closer on the client device's display screen.

3. The network device of claim 1, wherein selectively displaying the plurality of avatars further comprises grouping the plurality of avatars based in part on at least one of a geographical location of a member associated with each avatar, or a social relationship.

4. The network device of claim 1, wherein a conversation bubble is displayed during the communication between the user and the member.

5. The network device of claim 1, wherein the processor that is operative to perform actions, comprising:
if other members are detected to be communicating with each other, and such communications excludes participation by the user, then displaying a conversation bubble in proximity to avatars associated with the other members, wherein information indicating a context of the communications is absent from the conversation bubble to indicate that the conversation is private.

6. A processor readable storage medium that includes data and instructions, wherein the execution of the instructions on a computing device provides for managing a messaging session by enabling actions, comprising:
receiving contact information for a user, wherein the contact information includes information about a plurality of social networking members;
selectively displaying a plurality of avatars, each avatar representing one of the plurality of social network members, wherein the avatars are displayed relative to another avatar within a client device display screen associated with the user based in part on a frequency of interaction with the user;
receiving a request for a communication between the user and a member represented by one of the displayed avatars; and
in response to the request, automatically modifying a visual relationship between the avatar associated with the member participating in the communication with the user and at least one other displayed avatar.

7. The processor readable storage medium of claim 6, wherein modifying a visual relationship further comprises moving the avatar of the communicating member within a physical proximity to an avatar of the user within the display screen such that the avatar of the communicating member is moved closer to the avatar of the user than a non-communicating member's avatar.

8. The processor readable storage medium of claim 6, wherein selectively displaying the plurality of avatars further comprises displaying an online status of each respective member based on a configuration of avatar that comprises at least one of a grouping of avatars with other avatars to indicate whether a member is online or offline, a coloring of an avatar to indicate online status, a transparency, a size of an avatar, a position of an avatar.

9. The processor readable storage medium of claim 6, wherein execution of the instructions enable actions, further comprising:
In response to detecting at least two members communicating with each other independent of a communications with the user, displaying a visual indicator useable to indicate that the at least two members are communicating; and
if at least one of the members in the detected communications is absent from the user's contact information, modifying that member's avatar to indicate that that member is not in the user's contact information.

10. The processor readable storage medium of claim 6, wherein execution of the instructions enable actions, further comprising:
if it is detected that the user selects an avatar associated from within the plurality of social networking members, moving the selected avatar automatically forward with respect to at least one other displayed avatar; and
providing information about a member associated with the selected avatar.

11. The processor readable storage medium of claim 10, wherein the information provided about the member further comprises lifestreaming information.

12. A method for managing a communications, comprising:
identifying contact information from a user and a plurality of members to a social network;
employing the contact information to display within a computer display screen a messaging session that visually displays a plurality of avatars, each avatar being associated with a member within the plurality of members, and wherein each avatar is displayed relative to another avatar based in part on a user preference grouping, and a frequency of interaction with the user;
receiving a request for a communication between the user and a member represented by one of the displayed avatars; and
in response to the receiving the request enabling the communication session to be established and further automatically modifying a visual relationship between the avatar associated with the member participating in the communication with the user and at least one other displayed avatar to indicate that the member is in communications with the user.

13. The method of claim 12, wherein modifying the visual relationship further comprises displaying the communicating member's avatar closer to an avatar associated with the user than an avatar associated with a non-communicating member.

14. The method of claim 12, wherein modifying the visual relationship further comprises displaying a conversation bubble for use in conducting the messaging session.

15. The method of claim 12, wherein the user preference grouping is based at least on one of a label associated with each member in the contact information, an online browsing activity of a member, or an online status of a member.

16. The method of claim 12, wherein displaying avatars based on a frequency of interaction with the user further comprises displaying each avatar in relative proximity to an avatar associated with the user based on the frequency of interaction with the user.

17. A system for enabling a communications over a network, comprising:
a data store configured to manage contact information for a plurality of members to a social network; and
avatar messaging component that includes data and instructions, wherein the execution of the instructions on a computing device enable actions, comprising:
determining frequencies of interactions between each of the plurality of members and a user of a client device;
displaying a plurality of avatars, each avatar representing one of the plurality of members, wherein the avatars are displayed relative to another avatar within a display screen associated with the user based in part on the determined frequencies of interactions with the user;
receiving a request for a communication between the user and a member represented by one of the displayed avatars; and
in response to the request, enabling a communication session between the member and the user and further automatically modifying a visual relationship between the avatar associated with the member participating in the communication with the user and at least one other displayed avatar wherein the modification indicates that the communication session is active with the user.

18. The system of claim 17, wherein displaying the plurality of avatars, further comprises:
determining a relationship grouping between the plurality of members, and further displaying the plurality of avatars based additional on the relationship grouping.

19. The system of claim 17, wherein modifying a visual relationship further comprises moving the avatar associated with the communicating member closer to an avatar associated with the user than a non-communicating member's avatar.

20. The system of claim 17, wherein the avatar messaging component enable actions, further comprising:
if at least two other members are detected conducting a communication session, independent of participation by the user, displaying a communication indicator identifying the at least two other members are communicating; and
if the communication between the at least two other members is determined to be private to the user, inhibiting display of a context of the communication between the at least two other members.
